(19) United States
(12) Patent Application Publication
(10) Pub. No.: US 2024/0005427 A1
(43) Pub. Date: Jan. 4, 2024

(54) ORCHESTRATION LAYER FOR A MULTI-TIER ARCHITECTURE

(71) Applicant: Bank of America Corporation, Charlotte, NC (US)

(72) Inventors: Michael Betsko, Chandler, AZ (US); Ryan S. Heller, Newark, DE (US); Vince Holt, Dallas, TX (US); Igor Derensteyn, Los Angeles, CA (US); Murali Chowdarapu, Simi Valley, CA (US); Saurabh Khanna, Frisco, TX (US); David Smiddy, Chadds Ford, PA (US); Sreelatha Sankararaman, Plano, TX (US)

(21) Appl. No.: 17/853,257

(22) Filed: Jun. 29, 2022

(51) Int. Cl. G06Q 50/18; G06F 9/54; H04N 1/00; G06F 40/186

(52) U.S. Cl. CPC G06Q 50/18; G06F 9/547; H04N 1/00095; G06F 40/186

(57) ABSTRACT

An orchestrated services layer system for a multi-tier architecture is provided. The system may include an electronic signature application programming interface (API) and an electronic signature framework. The API may receive a request for electronic signature relating to a specific transaction. The request may include an identi-authenti object that authenticates and identifies a customer, customer identification data and transaction data. The API may retrieve a template associated with the transaction data. The API may transfer the request, or a portion of the request and the template to a framework. The framework may prepare a document-to-sign by adding personalized customer information to the document, selecting a type of electronic signature and adding signature tags to the document. The framework may return the ready-to-sign document to the API. The API may forward, for signature, the ready-to-sign document to a channel associated with the customer.

### FIELD OF TECHNOLOGY

Aspects of the disclosure relate to target state application programming interface (API) services.

### BACKGROUND OF THE DISCLOSURE

In relatively large industries, a million or more transactions take place each month. Each of the transactions typically requires one or more signatures. Presently, most entities use electronic signatures in place of non-electronic signatures.

Currently, there exists only a single version of an electronic signature solution. The single version provides a high-end, resource-intensive, heavy-technical footprint electronic signature solution.

Entities have been using the single electronic signature solution for all of their electronic signature needs. It should be noted that certain events may be able to leverage a simpler solution. These events do not need the high-end, resource-intensive, heavy-technical footprint of the single version electronic signature solution. For example, there are events that can utilize a click to sign option or a checkbox to indicate that a user agreed to a specific set of terms.

However, because of the ease of use associated with the single version of the electronic signature single version, and because no available framework exists for less resource intensive signing procedures, it is common for all of an entity's signatures to utilize the high-end, resource-intensive electronic signing procedure.

Therefore, it would be desirable to create an orchestration layer. It would be further desirable for the orchestration layer to receive all signature requests. It would be further desirable for the orchestration layer to connect with each of multiple tiers within a multi-tier architecture. It would be desirable if each of the tiers may correspond to a discrete signing process. As such, it would be desirable for the orchestration layer to determine which signing process is appropriate for the event. It would be further desirable for the orchestration layer to communicate with the necessary modules to facilitate the signing. It would be yet further desirable to provide an end-to-end source for the client to sign a document.

### SUMMARY OF THE DISCLOSURE

Apparatus, methods and systems that provide an orchestration services layer are provided. The orchestration services layer may include at least one hardware processor operating in tandem with at least one hardware memory. The orchestration services layer serves as a centralized device or box that receives electronic signature calls (also referred to herein as requests) from a plurality of clients. The plurality of clients may include financial centers, mobile applications, online applications and/or any other suitable clients.

The orchestration services layer may identify, for each electronic signature call, what document is required to be signed by the customer, a most appropriate way to receive the electronic signature of a customer of the client and any authentication required from the customer prior to the customer receiving the electronic signature. Various ways to receive the electronic signature of a customer of client may include a high-end, resource-intensive, heavy-technical footprint electronic signature, an email with a check box option, a voice-based approval and a web link to go to a web browser to provide a signature within the online browser.

The orchestration layer enables greater capabilities within an enterprise. Because the capabilities are all, or mostly, included within the enterprise, the orchestration layer strengthens an enterprise's electronic signature collection and storage process. The capabilities include retrieving a document template with which to create a document to be signed. The capabilities include identifying which signing procedure, from a plurality of signing procedures, is most appropriate for this specific customer and this specific document. These capabilities also include preparing, at a front-end module, the document with any metadata collected from the customer of the client. These capabilities also include adding any required tags to enable the customer to go through the signing process, and to indicate where on the document the customer should sign. The capabilities also include returning the ready-to-sign document to the front-end module.

The orchestration services layer also identifies and authenticates the customer (also referred to herein as the “signer”). The identification and authentication of the customer may involve various options based upon the channel in which the customer is being identified and authenticated.

In a banking center channel, identification and authentication may involve presenting identification documentation, such as a passport, driver's license, birth certificate, marriage license, social security card or any other suitable identification documentation to bank personnel. At times, the identification documentation may be electronically retrieved and stored at the banking center. Other times, the identification documentation may not be stored at the banking center. As such, the bank personnel may indicate on a computing device that the customer is identified and authenticated.

In a mobile device application channel or online application channel, identification and authentication may involve a username, a password, a one-time password and/or other suitable application electronic login information.

Authentication of the customer may involve asking questions to the customer and receiving correct responses from the customer. The questions may include “What is the last four digits of your social security number?” and “What is your account balance?” and other suitable questions.

Once the identification and authentication has been completed for a session, an identi-authenti object may be created. The identi-authenti object may be used throughout the signing process to identify and authenticate the customer. It should be noted that once the identi-authenti object has been created, the customer may not need to identify and/or authenticate at later time. This is significant because, in conventional systems and methods, the customer would be required to identify and authenticate at the beginning of a session and again just prior to the signing ceremony. As such the orchestration layer being able to pull the identi-authenti object throughout the session may reduce consumption of computer time and resources wasted during providing multiple identification and authentication services.

Additionally, at the beginning of a signing ceremony session, the customer may acknowledge what to use for a signature. The acknowledgement of what to use for a signature may include a predetermined signature font, a picture, an object or any other suitable signature particulars. In some embodiments, the acknowledgement may be created and stored for each signing ceremony. In certain embodiments, the acknowledgment may be created once and reused for each signing ceremony. A data log may be created to store the acknowledgement of what to use for a signature. In embodiments where the acknowledgment is created once and reused for each signing ceremony, the data log may be updated each time the signature is used to sign a document.

The orchestration layer may receive metadata from the customer. The metadata may include details relating to the customer. Such details may include customer name, customer address, customer telephone number and other suitable customer details. The metadata may share information used to generate the identi-authenti object. The metadata may be different from the information used to generate the identi-authenti object. The metadata may be retrieved from the customer and be used, via the orchestration services layer, to generate a personalized document for the customer.

An API may retrieve a template corresponding to a document to be generated for the customer. In some embodiments, a request for document generation may be accompanied by a template identifier. The API may transmit the received template identifier to one or more repositories. The repositories may respond to the request with a document that corresponds to the template identifier. In certain embodiments, the request for document generation may not be accompanied by a template identifier. In such embodiments, the API may determine, based on details included within the request, which template to retrieve.

Once the template is retrieved, the API may forward the template and the received metadata to a framework. The framework may prepare the document for the signer. As such, the framework may insert the received metadata into appropriate locations within the document. As such, the framework may create a ready-to-sign document.

At times, the framework may place the personalized text into empty spaces within the document. As such, it may be apparent to the signer that a template was used, and its personal information has been input into the document.

Other times, the framework may re-generate the document so that the personalized text is part of the document. As such, it may appear to the signer that the document has been generated for the signer and a template has not been used.

The framework may also add signing tags to the document. The signing tags may be locations within the document to indicate to the customer where to sign the document.

In some embodiments, a template may not be used. As such, data repositories may be able to build documents in real-time. Each organization and sub-organization may store document information in one or more repositories. A document builder may be able to access each of the repositories to build a document upon request for the document. In an example, the document builder may build closing documentation for a property closing. A document requestor may pass the variables, such as metes and bounds of the property, price, closing conditions, etc., that are to be included in the document. The customer information can be mapped from a storage location to the document, as opposed to being passed to the document builder. Therefore, in the event that customer information has been modified within a customer information storage location, or an additional field is added to the customer information database, the modification or additional field is retrieved by the document builder absent any additional technical processes.

Once the framework generates the ready-to-sign document, the framework may pass the ready-to-sign document back to the API. The API may forward the ready-to-sign document to the customer. The customer may sign the document using one or more tools, such as a mobile device, tablet, personal computer or other suitable computing device.

In the event that the customer rejects the ready-to-sign document, the rejected document (also, referred to herein as a voided envelope) may be forwarded to the orchestration services layer. The orchestration layer may store the voided envelope in a repository for reconciliation purposes.

The orchestration services layer may also pass the information regarding the voided envelope to a remediation module. The remediation module may attempt to persuade the customer to enter into a contract with the enterprise by providing one or more remediation measures. The remediation measures may include lowering an interest rate, improving terms of a contract and other suitable remediation measures.

When a customer does sign a document, an approval object may be created. The approval object may include information regarding the signature of the document (also referred to herein as an approval). The approval object may include the method in which the customer consented to, signed or approved the document. The approval object may be stored together with the document and the identi-authenti object at one or more repositories or systems or record (SORs).

Once the customer signs, or otherwise approves the document, one or more modules associated with the orchestration layer, may place a digital seal on the document. The digital seal may be unique to both the document and the signer. As such, the digital seal may identify the person and the document. The digital seal may make the document both unique and non-modifiable.

It should be noted that each time an event occurs in the signing process, a sub-entity, such as a client application, may be able to be notified. The events may include receiving metadata from the customer, creating the document, transmitting the document to the customer, receiving the signed document from the customer and storing the signed document at a repository. The client application may subscribe to notification at each stage in the process and/or the client application may subscribe to notification once the document has been signed. The event notification may be used for reconciliation purposes. At each step in the process, there is a query of whether the step has been complete. Once all of the required steps are complete, the reconciliation process prepares a report that states that each of the events have occurred for a specific document identifier.

At times, a process was completed and one of the process steps was inadequate. As such, the reconciliation data may be used to identify which part of the process steps was inadequate. In an example, if an account was opened and a signed account opening document was not stored within a repository, the system can identify, based on the reconciliation process, which steps were performed and which steps were not performed.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure; and

FIG. 5 shows still yet another illustrative diagram in accordance with principles of the disclosure.

### DETAILED DESCRIPTION OF THE DISCLOSURE

Apparatus, methods and systems for providing an orchestrated services layer is provided. Methods may include receiving authentication and identification information from a customer via a communications channel.

Methods may include creating an identi-authenti object at the communications channel. The communications channel may be a banking center, mobile application, online application or other suitable communications channel. The identi-authenti object may authenticate and identify the customer. The data used to create the identi-authenti object may be based on the communications channel.

When the communications channel is a physical banking center, the identifying the customer may include presenting identification documentation at the banking center. When the communications channel is a remote communications channel, the identifying may include entering a username and password.

Methods may include generating a request for an electronic signature. The request may relate to a specific transaction. The request may be for transmission through the communications channel.

Methods may include requesting identification data relating to the customer. The identification data may be for use with satisfying the request. Methods may include receiving the identification data relating to the customer. The identification data relating to the customer may be different from the identification information received from the customer. The identification data relating to the customer may include at least a portion of the identification information received from the customer.

Methods may include transmitting data relating to the specific transaction, a set of identification data relating to the customer and the identi-authenti object to the orchestrated services layer.

Methods may include receiving, at an API included in the orchestrated services layer, data relating to the specific transaction, the set of identification data relating the customer and the identi-authenti object.

Methods may include identifying, at the API, a transaction identifier for the specific transaction. Methods may include transmitting the transaction identifier from the API to a document services hub.

Methods may include transmitting the transaction identifier from the document services hub to a document services repository. Methods may include retrieving, from the document services repository, a template appropriate for the transaction identifier.

Methods may include transmitting the template from the document services repository to the document services hub. Methods may include transmitting the template from the document services hub to the API.

Methods may include transmitting, from the API to a framework included in the orchestrated services layer, the template, the set of identification data relating to the customer and the identi-authenti object.

Methods may include preparing a document-to-sign at the framework. The preparing may include adding the set of identification data of the customer to the document-to-sign. The preparing may include adding signature tags to the document-to-sign. The preparing may include selecting a type of electronic signature for the document-to-sign. The type of electronic signature may be a technical signature comprising geographic location awareness. The type of electronic signature may be a check-the-box signature. The type of electronic signature may be an acknowledgement signature. The type of electronic signature may include a combination of various types of electronic signatures. The type of signature selected may be based both on the document and the signer.

Methods may include transmitting the document-to-sign from the framework to the API. Methods may include transmitting the document-to-sign from the API to the communications channel. Methods may include receiving an electronic signature from the customer at the communications channel.

Methods may include, prior to electronically signing the document-to-sign, acknowledging, by the customer at the communications channel, a file that constitutes a signature. The file may include an image or a signature font.

Methods may include forwarding a signed document to the API. The signed document may include the document-to-sign and the electronic signature.

Methods may include forwarding the signed document from the API to the document services hub. Methods may include forwarding, for storage, the signed document, from the document services hub to the document services repository. Methods may include storing the signed document at the document services repository.

At times, the identi-authenti object and the signed document may be stored at the document services repository.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

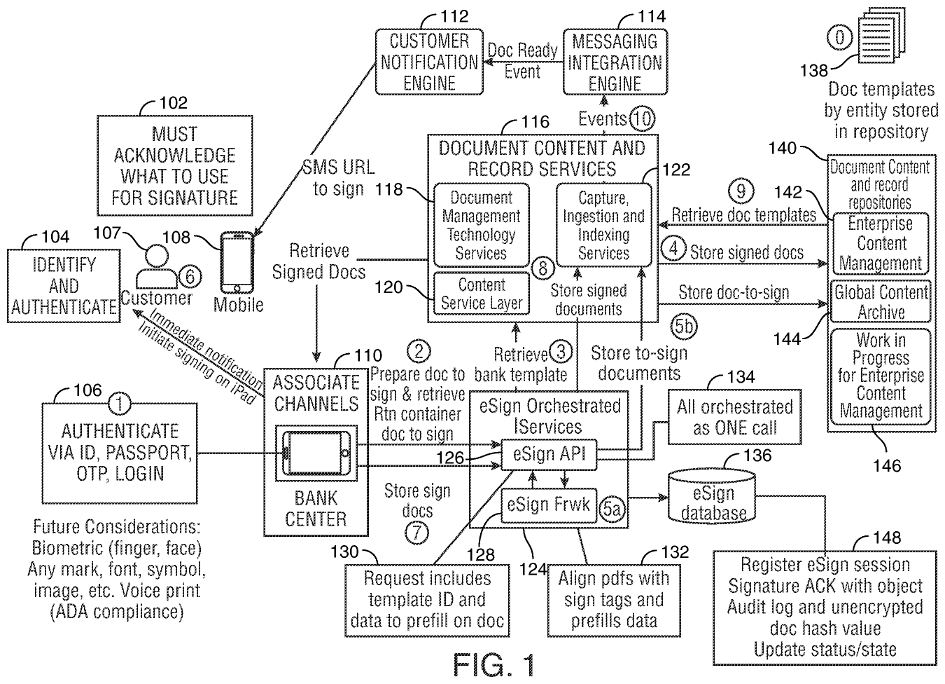

FIG. 1 shows an illustrative diagram. Customer 107 may be associated with mobile device 108. Customer 107 may want to sign a document. The document may be part of one of a variety of processes. Such processes may include becoming involved in a business relationship (contract administration), opening an account or any other suitable processes.

In order to enable customer 107 to sign a document, customer 107 may be required to identify and authenticate itself (shown at 104). The identification and authentication process may create an identi-authenti object. Authentication may involve authenticating via an identifier, one-time password (OTP) and/or login credentials, as shown at 106. Additional considerations may involve biometric (finger or face), any mark, font or symbol, image, etc., or voice print. Biometrics, such as finger or face, any mark, font or symbol, image, etc. or voice print may be used to authenticate customer 107.

An identi-authenti object may be created once customer 107 is identified and authenticated. The identi-authenti object may prove that the customer has been both identified and authenticated. The identi-authenti object may be used continuously and/or consistently throughout the process, so there is no need for re-identification and/or re-authentication at a later point in the process.

The identification and authentication may occur at a plurality of channels. One channel may be banking or financial center, as shown at 110. Another channel may be an online banking module. Yet another channel may be an automated teller machine. It should be noted that any suitable channel may interface with the orchestration layer.

The channel may transmit a signature request to electronic signature orchestration services 124. The signature request may include information relating to the authentication. The signature request may include information relating to the signer. The information relating to the signer may be referred to as metadata. The metadata may include the signer's name and address as well as any other suitable information. The metadata may also include information relating to what the signer has acknowledged as its signature, as shown at 102. For example, if the signer is using a particular signature font, if the signer is using an object, or if the signer is using a picture. The metadata relating to what the signer has acknowledged as its signature can be retrieved at each signing ceremony or it can be acknowledged a single time and stored for future use. In the event that the metadata is stored, the system may generate an audit log. The audit log may include information as to what the user acknowledged as its signature. Each time the user utilizes the signature, the information relating to the specific signing may be added to the audit log. As such, the audit log may be updated each time the user utilizes the stored signature.

The identi-authenti object as well as what the user acknowledged as its signature may be stored in electronic signature database 136. Electronic signature database 136 may be used to register electronic signature session, as shown at 148. Electronic signature database 136 may also be used to connect the signature acknowledgement with the identi-authenti object. Electronic signature database 136 may also store the audit log and the unencrypted document hash value. The updates to the status or state of the audit log may also be stored at electronic signature database 136.

The signature request may also include information relating to the document to be signed. The signature request may also include the identi-authenti object.

Electronic signature orchestrated services 124 may include both electronic signature application programming interface (API) 126 and electronic signature framework 128. Electronic signature API 126 may decide based on a series of coded aspects, such as lookup table, as to what type of signature is required for the current use case. Upon the decisioning, electronic signature API 126 may return to the calling application, a list of required data elements. The data elements may include metadata relating to the signer.

Once the data elements are received, electronic signature API 126 may communicate with electronic signature framework 128. Electronic signature framework 128 may include a utility for document creation. In certain embodiments, the utility for document creation may utilize at least three elements to create the document, the first element may include a template identifier, the second element may include data relating to the signer and the third element may include signature tags to be placed on the document. Each of the three elements may be orchestrated as one call, as shown at 134.

It should be noted that the request from the channel to the orchestrated services layer may include a template identifier and/or data to prefill onto the document, as shown at 130. Electronic signature framework 128 may align documents (such as, for example, portable document formats (PDFs)) with signature tags and prefill data, as shown at 132.

Upon receipt of a request for document, electronic signature API 126 may retrieve a template from document content and record services 116. The template may correspond to a template identifier received from the channel. The template may refer to a specific document, such as a loan contract. Document content and record services 116 may be a document storage and retrieval system. Document content and record services 116 may include various applications. The applications may include document management technology services 118, content services layer 120, and capture, ingestion and indexing services 122.

Document content and record services 116 may communicate with document content and record repositories 140 to retrieve the document template. Document content and record repositories 140 may include one or more applications: enterprise content management 142, global content archive 144 and work in progress for enterprise content management 146. It should be noted, as shown at 138, that document templates may be stored by one or more entities, or sub-entities, within the repository, prior to initialization of a signature request.

Because the orchestration layer serves multiple channels, there may be different process flows for each of the channels. A first process flow may involve a customer at a banking center. A second process flow may involve a customer using an online or mobile application.

When a signature request is initiated at a banking center, such as in the first process flow. A customer may be currently at the center. The template may be retrieved from the repository and forwarded from document content and record services 116 to electronic signature orchestration services 124. Electronic signature orchestration services 124 may forward the template to electronic signature framework 128 for document preparation, including personalizing the document using the received metadata and adding signature tags. Electronic signature framework 128 may forward the ready-to-sign document back to the electronic signature API 126. Electronic signature API 126 may forward the ready-to-sign document to the channel, as shown at 110. Customer 107 may provide an electronic signature at an electronic device within the channel. The signed document may be forward from channel 110 to electronic signature API 126, to capture, ingestion and indexing services 122 within document content and record services 116. Capture, ingestion and indexing services 122 may forward to signed documents to be stored within document content and record repositories 140.

When a signature request is initiated with a remote customer, such as one that is associated with mobile device 108, the doc-to-sign is stored at document content and record repositories 140 simultaneous to being transmitted to the customer. As such, when the customer decides to open the electronic signature notification, the system retrieves the doc-to-sign from document content and record repositories 140 and presents the document to the customer.

Additionally, events may be used to notify the sub-entity involved in the signing document. For example, when the document is ready to be signed, messaging integration engine 114, may generate the event, as the document ready to be signed event. Messaging integration engine 114 may be a message queue events handler.

An event may be generated when the uniform resource locator (URL) or short message service (SMS) is transmitted from customer notification engine 112 to the customer's device. The electronic signature API 126 may also generate an event when the customer signs the document. Each of these events may be reported to the sub-entity involved in the signing of the document.

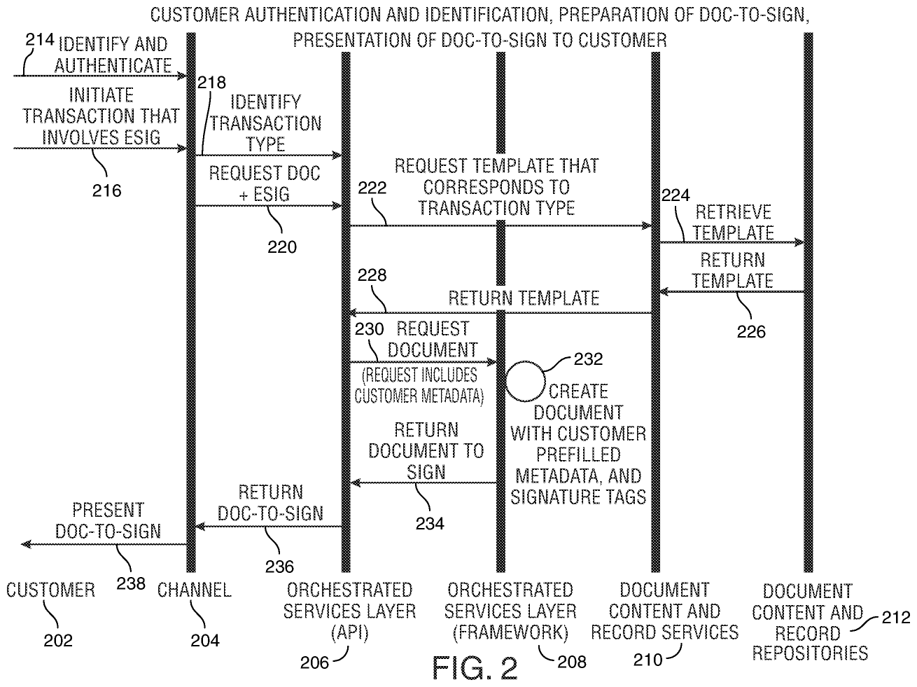

FIG. 2 shows an illustrative diagram. The illustrative diagram shows requests and responses within customer identification and authentication, document-to-sign preparation and presentation of document-to-sign to customer processes. The illustrative diagram shows communications between customer 202, channel 204, orchestrated services layer—API 206, orchestrated services layer—framework 208, document content and record services 210 and document content and record repositories 212.

Customer 202 may identify and authenticate at channel 204, as shown at 214. Customer 202 may initiate a transaction that involves an electronic signature, as shown at 216.

Channel 204 may identify a transaction type, as shown at 218. A document identifier may identify the transaction type. Channel 204 may request a document and an electronic signature from the API at orchestrated services layer 206.

The API at orchestrated services layer 206 may request, from document content and record services 210, a template that corresponds to the identified transaction type, as shown at 222.

Document content and record services 210 may retrieve a template from document content and record repositories 212, as shown at 224. Document content and record repositories 212 may return a template to document content and record services, as shown at 226.

Document content and record services 210 may return the template to the API at orchestrated services layer 206, as shown at 228.

The API at orchestrated services layer 206 may request a document from the framework at orchestrated services layer 208, as shown at 230. The framework at orchestrated services layer 208 may create a document with customer prefilled metadata and add signature tags, as shown at 232.

The framework at orchestrated services layer 208 may return a ready-to-sign document to the API at orchestrated services layer 206, as shown at 234. Orchestrated services layer 206 may return the ready-to-sign document to channel 204, as shown at 236. Channel 204 may present the ready-to-sign document to customer 202, as shown at 238.

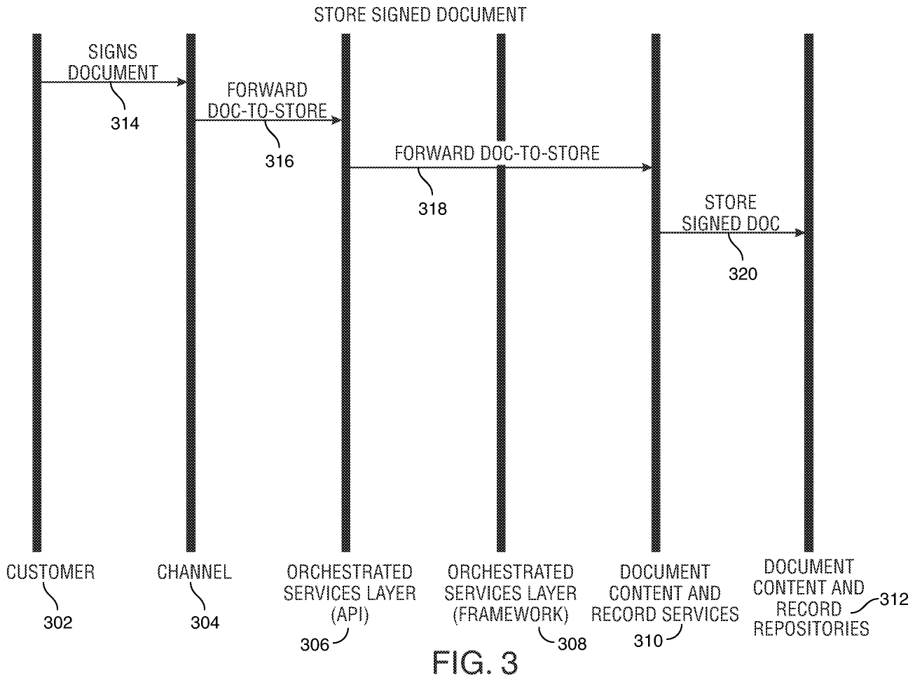

FIG. 3 shows an illustrative diagram. The illustrative diagram shows requests and responses that occur within storing a signed document process. The illustrative diagram shows communications between customer 302, channel 304, orchestrated services layer—API 306, orchestrated services layer—framework 308, document content and record services 310 and document content and record repositories 312.

Customer 302 may sign a document at channel 304, as shown at 314. Channel 304 may forward the document-to-be-stored to the API at orchestrated services layer 306, as shown at 316. API at orchestrated services layer 306 may forward the document-to-be-stored to document content and record services 310, as shown at 318. Document content and record services 310 may store the signed document at document content and record repositories 312, as shown at 320.

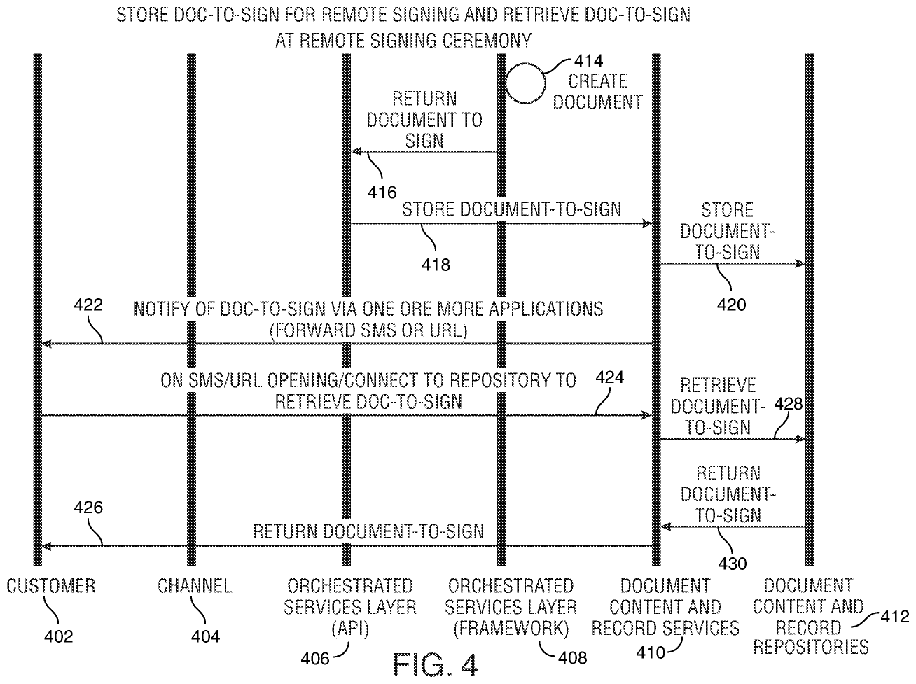

FIG. 4 shows an illustrative diagram. The illustrative diagram shows requests and responses that may occur within storing a document-to-be-signed for remote signing process and retrieving the document-to-be-signed at the remote signing process. The illustrative diagram shows communications between customer 402, channel 404, orchestrated services layer—API 406, orchestrated services layer—framework 408, document content and record services 410 and document content and record repositories 412.

Framework at orchestrated services layer 408 may create a ready-to-sign document, as shown at 414. The ready-to-sign document may be returned from framework at orchestrated services layer 408 to API 406, as shown at 416. API 406 may forward the document-to-sign to document content and record services 410 for storage, as shown at 418. Document content and record services 410 may store the document-to-sign at document content and record repositories 412, as shown at 420.

Document content and record services 410 may notify customer 402 of the document-to-sign via one or more applications, as shown at 422. The one or more applications may include forwarding an SMS or URL to a phone number or email address associated with customer 402.

Upon opening of the SMS or URL, customer 402 may connect to document content and record services 410 to retrieve the document-to-sign, as shown at 424. Document content and record services 410 may retrieve the document to sign from document content and record repositories 412, as shown at 428. Document content and record repositories 412 may return the document to sign to document content and record services 410, as shown at 430. Document content and record repositories 412 may return the document-to-sign to customer 402, as shown at 426.

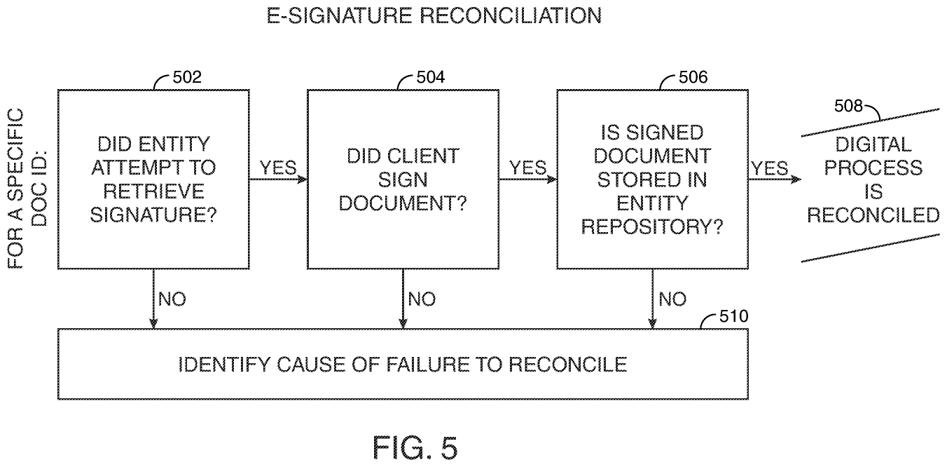

FIG. 5 shows an illustrative diagram. The illustrative diagram shows electronic signature reconciliation. For a specific document identifier, step 502 queries whether the entity attempted to retrieve a signature. When the answer to step 502 is yes, the process proceeds to step 504. When the answer to step 502 is no, the process proceeds to step 510.

Step 504 queries whether the client signed the document. When the answer to step 504 is yes, the process proceeds to step 506. When the answer to step 504 is no, the process proceeds to step 510.

Step 506 queries whether the signed document is stored in the entity repository. When the answer to step 506 is the digital process is reconciled, as shown at 508. When the answer to step 506 is no, an identification of the cause of the failure to reconcile is initiated. The identification may involve identifying which step in the process failed and what was the cause of the failure.

Thus, an orchestration layer for a multi-tier architecture is provided. Persons skilled in the art will appreciate that the present invention can be practiced by other than the described embodiments, which are presented for purposes of illustration rather than of limitation. The present invention is limited only by the claims that follow.

What is claimed is:

1. A method for providing an orchestrated services layer, the method comprising:
receiving authentication and identification information from a customer via a communications channel;
creating an identi-authenti object at the communications channel, said identi-authenti object authenticating and identifying the customer;
generating a request, said request for transmission through the communications channel, for an electronic signature, said request relating to a specific transaction;
requesting identification data relating to the customer, said identification data for use with satisfying the request;
receiving the identification data relating to the customer;
transmitting data relating to the specific transaction, a set of identification data relating to the customer and the identi-authenti object to the orchestrated services layer;
receiving, at an application programming interface included within the orchestrated services layer, data relating to the specific transaction, the set of identification data relating to the customer and the identi-authenti object;
identifying, at the application programming interface, a transaction identifier for the specific transaction;
transmitting the transaction identifier from the application programming interface to a document services hub;
transmitting the transaction identifier from the document services hub to a document services repository;
retrieving, from the document services repository, a template appropriate for the transaction identifier;
transmitting the template from the document services repository to the document services hub;
transmitting the template from document services hub to the application programming interface;
transmitting, from the application programming interface to a framework included in the orchestrated services layer, the template, the set of identification data relating to the customer and the identi-authenti object;
preparing a document-to-sign at the framework, the preparing comprising:
adding the set of identification data of the customer to the document-to-sign;
adding signature tags to the document-to-sign; and
selecting a type of electronic signature for the document-to-sign;
transmitting the document-to-sign from the framework to the application programming interface;
transmitting the document-to-sign from the application programming interface to the communications channel; and
receiving an electronic signature from the customer at the communications channel, said electronic signature that converts the document-to-sign into a signed document.

2. The method of claim 1, wherein the communications channel is a banking center, mobile application or online application.

3. The method of claim 1, wherein data used to create the identi-authenti object is based on the communications channel.

4. The method of claim 3, wherein the communications channel is a physical banking center, and the identifying includes presenting identification documentation at the banking center.

5. The method of claim 3, wherein the communications channel is a remote communications channel, and the identifying includes entering a username and password.

6. The method of claim 1, wherein the identification information received from the customer and the set of identification data relating to the customer is different data.

7. The method of claim 1, wherein the set of identification data relating to the customer includes at least a portion of the identification information received from the customer.

8. The method of claim 1, further comprising, prior to electronically signing the document-to-sign, acknowledging, by the customer at the communications channel, a file that constitutes a signature.

9. The method of claim 8, wherein the file includes an image or a signature font.

10. The method of claim 1, wherein the type of electronic signature for the document-to-sign is either a technical signature comprising geographic location awareness, a check-the-box signature or an acknowledgement signature.

11. The method of claim 1, further comprising:
forwarding a signed document comprising the document-to-sign and the electronic signature from the communications channel to the application programming interface;
forwarding the signed document from the application programming interface to the document services hub;
forwarding, for storage, the signed document, from the document services hub to the document services repository; and
storing the signed document at the document services repository.

12. The method of claim 1, further comprising storing the identi-authenti object with the signed document at the document services repository.

13. An orchestrated services layer system comprising:
an electronic signature application programming interface (API); and
an electronic signature framework;
wherein:
the API receives a request from a communications channel, the request for an electronic signature relating to a specific transaction, the request comprising:
an identi-authenti object that authenticates and identifies a customer;
a set of identification data relating to the customer; and
a set of data relating to the specific transaction;
the API identifies a transaction identifier for the specific transaction;
the API transmits the transaction identifier to a document services hub in communication with a document services repository;
the API receives a template that corresponds to the transaction identifier from the document services hub in communication with the document services repository;
the API transfers the template, the set of identification data relating to the customer and identi-authenti object to the framework;
to prepare a document-to-sign, the framework:
adds, to the template, the set of identification data relating to the customer;
adds, to the template, signature tags;
selects a type of electronic signature for the document-to-sign, the selection based on the specific transaction and the set of identification data relating to the customer;
the framework transfers the document-to-sign to the API; and
the API forwards the document-to-sign to the communications channel for electronic signature by the customer.

14. The system of claim 13, wherein:
the API receives a signed document, said signed document comprising the document-to-sign and the electronic signature, from the communications channel; and
the API forwards the signed document to the document services hub in communication with the document services repository for storage.

15. The system of claim 14, wherein the identi-authenti object is stored with the signed document at the document services repository.

16. The system of claim 13, wherein the type of electronic signature for the document-to-sign is either a technical signature comprising geographic location awareness, a check-the-box signature or a identify acknowledgement signature.

17. An orchestrated services layer system comprising:
an electronic signature application programming interface (API); and
an electronic signature framework;
wherein:
the API receives a request from a communications channel, the request for a remote electronic signature relating to a specific transaction, the request comprising:
an identi-authenti object that authenticates and identifies a customer;
a set of identification data relating to the customer; and
a set of data relating to the specific transaction;
the API identifies a transaction identifier for the specific transaction;
the API transmits the transaction identifier to a document services hub in communication with a document services repository;
the API receives a template that corresponds to the transaction identifier from the document services hub in communication with the document services repository;
the API transfers the template, the set of identification data relating to the customer and identi-authenti object to the framework;
to prepare a document-to-sign, the framework:
adds, to the template, the set of identification data relating to the customer;
adds, to the template, signature tags;
selects a type of electronic signature for the document-to-sign, the selection based on the specific transaction and the set of identification data relating to the customer;
the framework transfers the document-to-sign to the API;
the API forwards the document-to-sign to the document services hub in communication with the document services repository for storage; and
the API instructs the document services hub to transmit a message to a mobile device associated with the customer, the message comprising a link to access the document-to-sign stored in the document services repository.

18. The system of claim 17, wherein:
upon signing the document-to-sign on the mobile device, the API receives a signed document, said signed document comprising the document-to-sign and the electronic signature, from the mobile device; and
the API forwards the signed document to the document services hub in communication with the document services repository for storage.

19. The system of claim 18, wherein the identi-authenti object is stored with the signed document at the document services repository.

20. The system of claim 17, wherein the type of electronic signature for the document-to-sign is either a technical signature comprising geographic location awareness, a check-the-box signature or a identify acknowledgement signature.
